(19) United States
(12) Patent Application Publication
(10) Pub. No.: US 2005/0234738 A1
(43) Pub. Date: Oct. 20, 2005

(54) Competitive product intelligence system and method, including patent analysis and formulation using one or more ontologies

(76) Inventor: Alan S. Hodes, Menlo Park, CA (US)

Correspondence Address: ALAN S. HODES, 1755 POPPY AVE., MENLO PARK, CA, 94025-5737, US

(21) Appl. No.: 11/151,781

(22) Filed: Jun. 13, 2005

Related U.S. Application Data
(63) Continuation-in-part of application No. 10/788,532, filed on Feb. 27, 2004.
(60) Provisional application No. 60/525,402, filed on Nov. 26, 2003.
(60) Provisional application No. 60/581,932, filed on Jun. 22, 2004.

(51) Int. Cl. G06F 17/60

(52) U.S. Cl. 705/1

(57) ABSTRACT

A method and system is described using one or more ontologies to perform patent analysis and formulation. Using the ontologies, analysis of the claims is performed. The ontologies are such that comparison can be made between concepts in a patent claim sense of relative breadth.

### CROSS-REFERENCE TO RELATED APPLICATIONS

This application is a Continuation-in-part of prior U.S. application Ser. No.: 10/788,532 filed Feb. 27, 2004, from which priority under 35 U.S.C. §120 is claimed. Prior application Ser. No.: 10/788,532 claims the benefit of priority under 35 U.S.C. § 119 to U.S. Provisional Application No.: 60/525,402, filed Nov. 26, 2003. The present application also claims the benefit of priority under 35 U.S.C. §119 to U.S. Provisional Application No.: 60/581,932, filed Jun. 22, 2004. All of the above-identified applications are hereby incorporated by reference for all purposes.

### STATEMENT REGARDING FEDERALLY SPONSORED RESEARCH OR DEVELOPMENT

Not applicable

### REFERENCE TO A COMPACT DISK APPENDIX

Not applicable.

### TECHNICAL FIELD AND BACKGROUND

The present application is in the field of competitive product intelligence and, in some specific aspects, is in the field of analysis relating to patents and patent claims.

Competitive product intelligence and competitive product analysis includes, generally, collecting and analyzing information about products of competitors. For example, this may contribute to an effort to anticipate market developments and be proactive with respect to such anticipated market developments. Many organizations do not even attempt to conduct competitive product intelligence, and many other organizations that do conduct competitive product intelligence find that either they cannot collect sufficient information from which to analyze information about competitor products, or that they cannot sufficiently analyze the information they can gather such that they can determine suitable actions to take based on the analysis.

Recently (and even not so recently), many “data mining” techniques have been developed and marketed for “competitive intelligence” applications. In particular, such data mining techniques attempt to find relationships between concepts exhibited in disparate data. However, a drawback of such techniques is the way in which they present the results of the data mining. For example, for simplification purposes, many data mining techniques employ “clustering” to group together concepts that are “similar,” treating the distinctions between such similar concepts as noise. However, the distinctions may not be noise but, rather, may provide important competitive information, about significant product features, for example. Furthermore, what is “significant” may depend on numerous factors, many of which cannot be predetermined.

Furthermore, there are some products designed for analysis relating to patents. However, many of these products do not even consider the patent claims, which set forth the “metes and bounds” of the invention the patent is to protect. For example, the Aureka product does not appear to consider the patent claims, at least in any meaningful way. It has long been thought that analysis relating to patent claims is more of an art than a science. The detailed description portion of a patent application is a description of a particular embodiment and can typically be written and understood by a proficient technical writer. By contrast, the claims portion sets forth the legal bounds of an invention. That is, each claim sets forth the “elements” that must be present in an accused article of manufacture or method (or other patentable subject matter) in order for the accused article or method to literally infringe that claim.

If a patent claim sets forth elements that are not “essential,” then it is presumably easier for one to not include those non-essential elements in his article or method to avoid infringement. Similarly, even if an element is “essential” but it is recited in the patent claim in too great detail, one can avoid literal infringement of that patent claim by including a similar element in his article or method, but with different detail than is recited in the patent claim. What is “essential” is generally dependent on the content of the prior art and, to perhaps a lesser extent, definiteness, utility and other criteria as required, for example, by patent statutes and various patent doctrine.

There are at least two aspects of analysis relating to patent claims. One aspect is related to patent claim formulation. Another aspect is related to interpreting already-formulated claims (e.g., as present in issued patents) and is typically implicated in the process of determining whether a particular accused article or method infringes a claim or whether one or more particular prior art articles or methods invalidate a claim by anticipation or obviousness. The issues surrounding these aspects are inextricably intertwined. For example, see § 3.02[1] of Chisum on Patents, which states (citations omitted) “The classic test of anticipation provides: ‘That which will infringe, if later, will anticipate, if earlier.’ Thus, a claim fails to meet the novelty requirement if it covers or reads on a product or process found in a single source in the prior art.”

With specific regard to the first aspect of analysis relating to patent claims, it is desirable to relatively definitively determine, relative to the prior art (and to what was “invented” in the sense of 35 USC § 112, ¶ 1), what features of an embodiment may be recited in a patent claim as the claim elements and appropriate levels of detail for the recitations of the claim elements. With regard to the second aspect, the analysis with respect to the claim elements may be thought of as being essentially the converse of the analysis in the first aspect. That is, in the first aspect, it is first determined what is a possible scope of claim elements and then claim elements are formulated based on the determined desirable scopes. In the second aspect, the scope of each claim element is determined based on how that claim element has been formulated, perhaps with reference to extrinsic information as guided by relevant doctrine.

In each aspect, the determinations involved are conventionally typically highly affected by matters of human judgment. While some people are skilled and have a “knack” for such matters, many do not. Furthermore, the services of such skilled people can be quite expensive. In addition, even skilled people may have limited capacity to process and catalog large quantities of information that contribute to a more rigorous analysis.

There are automated tools in the field of patent analysis generally. However, a shortcoming of present tools for analysis relating to patents is that such tools generally simply do not address (adequately or at all) analysis relative to patent claims. For example, there is a conventional tool that is known to generate reports associating issued patents (and/or non-patent documents) with corresponding portions of a complete product. For example, U.S. Pat. No. 5,991,751 (“the '751 patent”) discloses maintaining a bill-of-materials (BOM) database of assemblies, sub-assemblies and parts, wherein the BOM also includes appropriate links to patents that “cover” the assemblies, sub-assemblies and parts. See, for example, col. 70 of the '751 patent. FIG. 108 of the '751 patent illustrates processing a BOM for a proposed product to map issued patents to the proposed product. The '751 patent discloses, at step 10810 in the FIG. 108 process, the following: “DETERMINE IF NEW PRODUCT IS ADEQUATELY PROTECTED BY PATENTS. IF NOT, CONSIDER FILING ADDITIONAL PATENT APPLICATIONS ON NEW PRODUCT.”

However, as best understood, the '751 patent does not describe any process to assist in drafting the additional patent applications, let alone to assist in drafting the claims of the additional patent applications. In the first place, while the report generated by the FIG. 108 process does ostensibly indicate whether features of the new products are “covered” by patents (somehow, without considering the actual claim language), no guidance is given as to how the additional patent applications (in particular, the claims) should be drafted in view of the others' patents. In addition, and perhaps even more significantly, it is not even clear that the FIG. 108 process is even properly (or, at least, rigorously) determining patent coverage. More specifically, as discussed above, it is the patent claims that define the invention for the purpose of determining infringement, that is, what constitutes the “patented invention” that persons cannot make, use or sell without the authority of the patent owner. See §8 of Chisum on Patents. The method disclosed in the '751 patent appears to consider much of the information in the patent documents in generating its “coverage” reports but, as best understood, the method disclosed in the '751 patent does not appear to consider the claims at all.

Furthermore, even if the method of the '751 patent considered the claims in generating its “coverage” charts (which it apparently does not), there is little or no guidance given in the '751 patent as to particular content in the “additional patent applications” which one should “consider filing.” More particularly, there is little or no guidance given as to how to formulate the claims of such “additional patent applications.”

One tool that appears to at least consider the patent claims the “Claims/Concept Search Technology” service provided by PatentCafe. However, it does not appear to parse out and separately treat and analyze the scope of the concepts represented by each claim element. Furthermore, with specific respect to the PatentCafe service, this service appears to be limited to a search application, and does not assist in more useful types of analysis that may be desirable and appropriate with respect to patent claims.

Furthermore, there has been research into tools that in some sense automatically generate patent claim text. For example, see Generating Patent Claims From Interactive Input in Proceedings of the 8th. International Workshop on Natural Language Generation (INLG'96), pages 61-70, Herstmonceux, England, June 1996 by Svetlana Sheremetyeva, Sergei Nirenburg, and Irene Nirenburg. However, as described at page 3 of the paper, it is the user who must describe “every essential feature of the invention” (albeit, with the guidance of the tool “requesting the user, in English, to supply information about the invention, its components, their properties and relations among them”). This is done to avoid the need for “a deep knowledge representation language for describing the invention.” Thus, while the tool may ease the process of patent claim drafting, like the method of the '751 patent, the automated tool does little or nothing to assist in what is many times the most daunting part of the claim drafting process—identifying what are the features of “the invention.”

Conversely, tools have been proposed to specifically analyze patent claims, as opposed to more coarsely analyzing patent documents as discussed above with regard to the '751 patent. For example, see Natural Language Analysis of Patent Claims, presented by Svetlana Sheremetyeva at ACL-2003 Workshop on Patent Corpus Processing (Workshop WS9), Jul. 12, 2003 in Sapporo, Japan.

In general, many of these tools are narrowly focused, such that they do not analyze the claims in the context of the prior art but, rather, consider the claims in an isolated manner. While the article referenced above, Generating Patent Claims From Interactive Input, does discuss using “knowledge” for patent claim text analysis (mentioning “applications of patent search and novelty expertise”), the article apparently does not consider or discuss what this entails or how it might be accomplished.

### BRIEF DESCRIPTION OF THE DRAWINGS

FIG. 1 illustrates an example independent patent claim.

FIG. 2 illustrates an example dependent patent claim, dependent on the independent claim illustrated in FIG. 1.

FIG. 3 broadly illustrates a process to use an ontology for a patent claim infringement analysis.

FIG. 4 broadly illustrates a process to use an ontology for a validity/patentability analysis.

FIG. 5 broadly illustrates a process to use an ontology for formulating patent claims.

FIG. 6 schematically illustrates an ontology in an abstract manner for simplification of illustration.

FIG. 7 illustrates the FIG. 4 process for formulating patent claims, with slightly greater detail.

FIG. 8 illustrates an example architecture of a system that may be employed to carry out the methods described herein.

FIG. 9 illustrates a process to use an ontology for competitive product analysis.

### DETAILED DESCRIPTION

Mechanical Aspects of Patent Claims

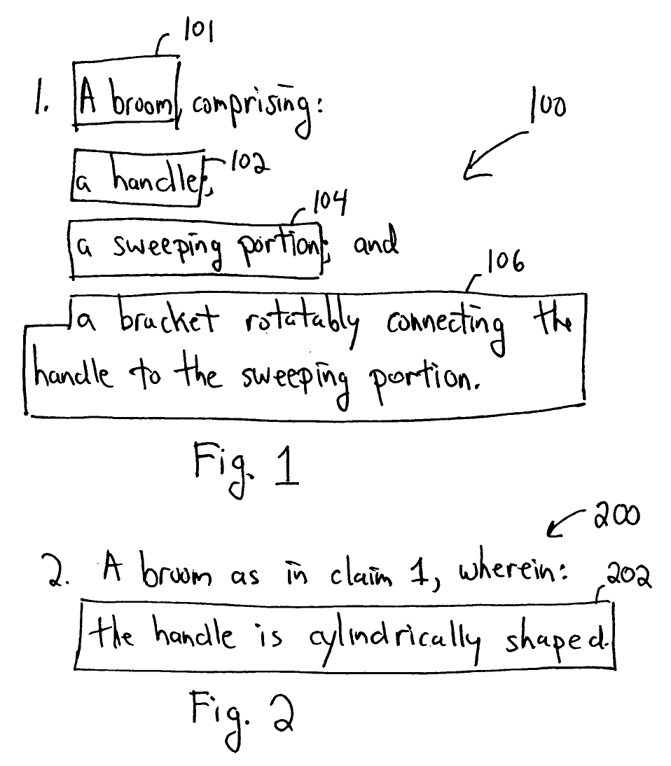

Before proceeding further, it is useful to first provide some foundational discussion. First, we consider some “mechanical” aspects of patent claims. A typical patent claim includes a plurality of portions, each portion typically called an “element.” Referring to FIG. 1, an example patent claim 100 is shown. In addition to the preamble 101, the claim 100 recites three elements, indicated by reference numerals 102, 104 and 106. While FIG. 1 illustrates an example of how the claim 100 may be divided up into “elements,” other divisions may be, and probably are, possible.

The claim should be “supported” by corresponding description in the patent specification (sometimes called patent “description”) as viewed from the point of view of one of ordinary skill in the art. This requirement is set forth at least in 35 §112, ¶¶ 1 and 2, for example, of the United States patent law, and similar (but typically not identical) requirements exist in jurisdictions other than the United States.

The patent description typically describes one or more “embodiments” of the invention. An “embodiment” typically includes a plurality of connected portions. For example, the portions may be components of an article of manufacture, steps of a process, or components of a composition of matter (which, typically, are covered by one or more corresponding claims of the patent). Furthermore, the description of an embodiment may be set forth in a hierarchical manner, such that the embodiment is described first at a high level (or, at least, some portions of the embodiment are described at a high level), and the portions of the high level description are further described at increasingly lower levels. The various portions of the embodiment may be described at varying levels as, for example, deemed appropriate according to the judgment of the patent practitioner drafting the patent application.

Typically, a claim element (for example, the “handle” claim element 102) does not exist in isolation. Rather, like the connected portions in the described embodiments, that claim element is typically a portion of the claim correspondingly recited to be connected in some way to at least one other claim element. A recitation of this connection may be within the recitation of the element itself, may be recited as a separate claim element (e.g., the “bracket” claim element 106), or may be inherent. On the other hand, in some cases, a connection is not recited.

Further considering the elements of patent claims, such claims are typically set forth in a hierarchical fashion. That is, independent claims stand on their own. Dependent claims are typically set forth that either further define an element recited further up in the hierarchy or that recite an additional element. (For example, 37 CFR 1.75(c) provides for a claim in a United States patent application to be set forth in dependent form.) FIG. 2 illustrates a dependent claim 200 that includes an element 202 that further defines the “handle” claim element 102 of the independent claim 100.

It should be noted that elements of a particular claim may, in fact, be like elements of a claim dependent on that claim—that further define an element recited in the same claim or that recite an additional element. Typically, but not always, such elements are included in a “wherein” clause.

Ontologies and Concepts

Still providing some foundation description, we now discuss “ontologies” and “concepts.” The notion of concepts and their relation to language has been the subject of much academic study. As just one example, an article entitled Ontology Development for Machine Translation: Ideology and Methodology, by Kavi Mahesh (the “Mahesh article”), discusses at page 5 that “a concept is a primitive symbol for meaning representation with well-defined attributes and relationships with other concepts.”

The Mahesh article also discusses what is an ontology. According to the Mahesh article, an ontology is, broadly stated, “a computational entity, a resource containing knowledge about what ‘concepts’ exist in the world and how the concepts relate to one another.”See Mahesh article, page 5. For the purposes of this description, an ontology may be a “computational entity,” but it is not necessarily so limited (e.g., it could be a resource with the property discussed by Mahesh, and represented as printed data on paper).

According to Mahesh, an ontology is, on its own, not related to any particular instance existing in the world. Thus, for example, an ontology is, on its own, not related to an embodiment described in a patent application, or to an apparatus, method, etc. described in “prior art,” nor is it related to a patent claim, for example. Rather, the ontology (or ontologies) provides a framework to which instances (such as the embodiment described in the patent application or the apparatus, method, etc. described in “prior art,” or a patent claim) may be mapped. More particularly, as will be seen later in this description, separate portions of instances may be mapped to concept nodes of one or more ontologies.

For example, Mahesh article discusses mapping concepts represented in input text in a first language into a language-neutral ontology, to achieve a “text meaning representation” or “TMR.” From the TMR, output text in a second language is generated. In this way, the language-neutral TMR facilitates translation from the first language into the second language.

As another example, in the Generating Patent Claims From Interactive Input paper, discussed in the Background, it is described that a “conceptual schema” is interactively traversed to help the user/inventor to express what is his invention. The conceptual schema may, in some sense, be considered an ontology. The conceptual schema itself is not related to what is the invention (or, at least, it does not have sufficient information from which a definition of the invention can be derived). This is shown perhaps more clearly in Interactive Knowledge Elicitation in a Patent Expert's Workstation, by Sheremetyeva, S. and S. Nirenburg, IEEE Computer 1996, which has overlapping authorship with the Generating Patent Claims from Interactive Input paper. More specifically, FIG. 1 of the Interactive Knowledge Elicitation in a Patent Expert's Workstation paper illustrates acquiring knowledge about the invention from a user/inventor, such that patent claim text can be generated, by a user interacting with ontologies.

To be sure, there is disagreement about what is a definition of “ontology.” Some academic articles discuss how an ontology differs (or does not differ) from a taxonomy, or even from a thesaurus (though the distinction between an ontology or taxonomy, and a thesaurus, appears to be more clear). In general, as the term is used in this patent application, an ontology is a resource (usually, but not necessarily, a computational resource) embodying knowledge about concepts and how they relate to each other, as discussed above with respect to the Mahesh article.

Furthermore, for the purposes of this patent application, the knowledge about how the concepts relate to each other is such that, at a minimum, it is determinable whether a particular concept is broader, narrower or not related to another concept in a patent claim scope sense. This should become more clear, if more clarity is in fact required, from the discussion in the remainder of this patent application, including but not limited to the discussion about how ontologies are used in analysis relating to patents and patent claims. The concepts are represented in an ontology by interrelated concept nodes, where the interrelationship between the concept nodes is indicative of the relative relationship between the corresponding concepts.

In fact, William A. Wood explicitly describes such a concept organization, which he calls a “conceptual taxonomy.” See William A. Woods, “Conceptual Indexing: A Better Way to Organize Knowledge” (Sun Microsystems Laboratories, 1997). (A primary purpose of the conceptual taxonomy, as disclosed by Wood, is to enable better searching.) Woods discloses that the conceptual taxonomy is organized such that one can determine various subsumption relationships between concepts represented by it. The “conceptual taxonomy” described by Woods appears to have characteristics such that fits the definition of “ontology” for the purposes of this patent application, as described above.

Broad Description of Various Uses of Ontologies for Performing Analysis Related to Patents and Patent Claims

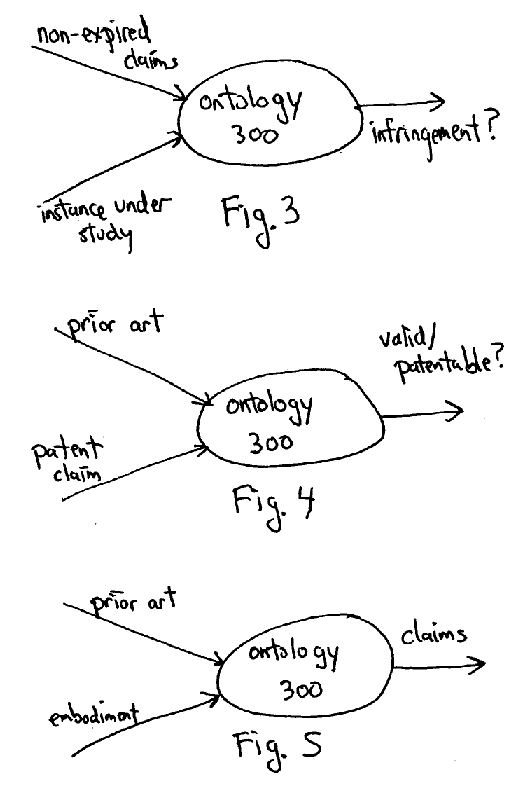

FIGS. 3, 4 and 5 broadly illustrate methods that use an ontology 300 for performing analysis relating to patents and patent claims. Instances in particular arts (e.g., portions of gene sequences, or portions of molecules) may perhaps be more naturally amenable to being mapped to ontologies of concept nodes, but instances in other arts are also able to be mapped to ontologies of concept nodes. For example, life sciences and chemistry, to name just a few areas, are areas in which there is more amenability to mapping of concepts relative to other arts, since this subject matter has generally been more completely categorized already.

FIG. 3 broadly illustrates a method using the ontology 300 for an infringement analysis. In a specific example, the portions of one or more claims are mapped to the concept nodes in the ontology 300. Similarly, an instance under study (e.g., an accused instance or an instance for which it is desired to determine if there is freedom to operate) is also mapped to the concept nodes in the ontology 300. The “portions” are elements (or, for instances, are akin to elements). As alluded to above, in the section entitled “Mechanical Aspects of Patent Claims,” an element is, in general, more than merely a word. Rather, an element is an entity unto itself that, for example, in an apparatus claim, completely defines a portion of the apparatus. As another example, in a method claim, an element completely defines a portion (step) of the method. A similar statement can be made about elements/portions of instances that are not patent claims.

The mapping of the claims is compared to the mapping of the instance from which it is determined whether the instance is covered by one or more claims (i.e., includes all of the limitations of the one or more claims). Of course, the question of infringement is ultimately a judicial question, and the formal authority with respect thereto is a court, a quasi-judicial authority, or some other party acting in lieu of the court, typically by agreement of the parties in dispute.

The comparison of the mapping is on an element-by-element basis. That is, attempt is made to “best match” each mapped concept for a claim to each mapped concept for the instance, to make the most tenable infringement contention. In some examples, one or more elements of the claim may be specifically tied (e.g., manually by user interaction) to one or more elements of the instance, and a best match is made of the remaining elements. To “best match,” an aggregate measure, over a plurality of sets of element matches, may use some statistical measure, to determine which of the various permutations of matches are optimal, as appropriate for a particular situation. It may be appropriate that “most” of the elements match, even though some are not even “close” (by some measure) or it may be appropriate that more of the elements are a better match, such that fewer are worse matches. It can be seen that, generally, there are various criterion by which an element-by-element comparison may be made between the claim and the instance relative to the FIG. 3 infringement analysis.

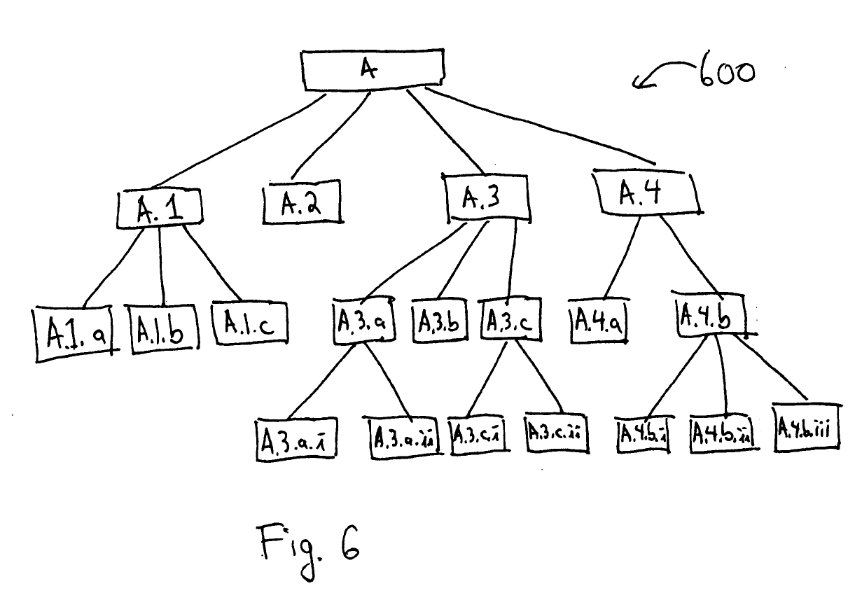

FIG. 4 broadly illustrates a method using the ontology 300 for a validity/patentability determination in view of prior art. The “prior art” is typically in the form of a “textual description” based on a publication, sale, offer for sale, or some other event in accordance with the relevant patent statute. In a specific example, the portions of a patent claim in question (as to its validity in view of prior art) are mapped to the concept nodes in the ontology 300. Similarly, the portions of a prior art instance are mapped to the concept nodes in the ontology 300. The mapping of the claim is compared to the mapping of the prior art, from which it is determined whether the claim is valid or patentable in view of the prior art (i.e., the prior art does not include all of the limitations of the claim). The comparing operation is similar to that described above with reference to FIG. 3.

Like with infringement, the question of validity is ultimately a judicial question. Patentability is an administrative question (i.e., is decided by the Patent Office and, perhaps, ultimately by a court in some cases). The validity question, if posed before the claim is ultimately allowed and/or issued in a patent, may be thought of as a patentability question. In either case—validity (post-issuance) or patentability (pre-issuance)—the inquiry, with respect to the claim in view of the prior art, can be essentially the same. Also, like in the infringement context, the comparison includes comparing a mapping of the claim to a mapping of the instance (“instance under study” in FIG. 3 and prior art instance in FIG. 4) to determine whether the instance includes all of the limitations in the claim. As discussed in the Background, Chisum has succinctly recognized, citing to case law, “That which will infringe, if later, will anticipate if earlier.”

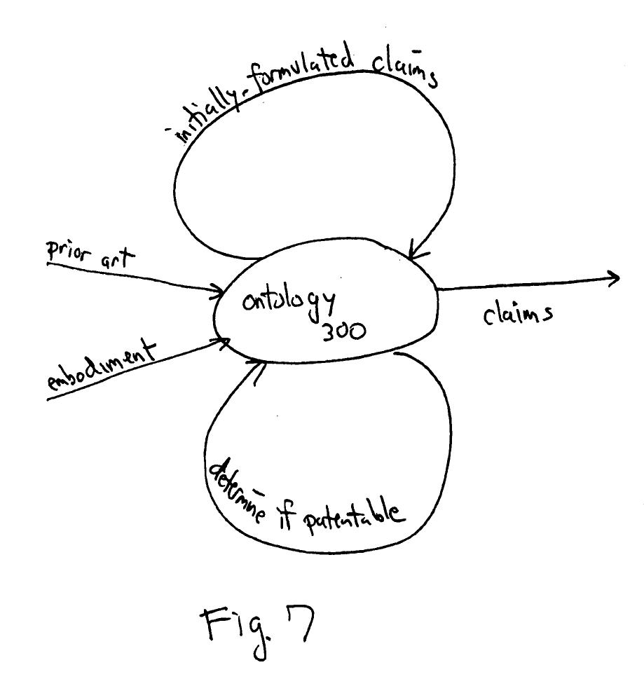

FIG. 5 broadly illustrates a method using the ontology 300 to formulate patent claims in view of prior art. In a specific example, the portions of a prior art instance are mapped to the concept nodes in the ontology 300. Similarly, the portions of an embodiment instance (from which claims are to be drawn) are mapped to the concept nodes in the ontology 300. The mapping of the prior art instance is compared to the mapping of the embodiment instance, and one or more claims, which are patentable in view of the prior art instance, are formulated based on the comparison.

Using an Ontology for Concept Scope Comparison

Turning for now away from FIGS. 3, 4 and 5, we discuss, more specifically, examples of using an ontology to compare the scope of concepts (i.e., whether a concept is broader or narrower, in a patent claim sense) to which element have been matched. To do so, we use a very simplified abstract example 600 of an ontology, illustrated in FIG. 6. As discussed several times above, at a minimum, an ontology as used herein includes knowledge from which it is determinable whether a particular concept is broader, narrower, or not related to another concept in a patent claim scope sense. Referring to FIG. 6, the ontology 600 includes hierarchically organized concept nodes, each concept node corresponding to a concept. The ontology is organized such that it can be determined that, for example, the concept represented by node A.1 is narrower than the concept represented by node A. Likewise, the concept represented by node A.1.a is narrower than the concept represented by the node A.1 (and narrower than the concept represented by the node A.) (For shorthand, we sometimes refer to a concept represented by a node “x” as, merely, “concept x.”)

FIG. 6 is not meant to imply a particular required specific organization of concepts in an ontology, only that the relationships (in a patent claim scope sense) between the concepts represented by the ontology are determinable, whatever the particular organization of the concepts. For example, the Mahesh article discusses (albeit, in a different context) various ontology organization and practical considerations with respect to such organizations. See the Mahesh article, which discusses ontologies with nodes that have a highly-populated internal structure, and which also mentions ontologies with relatively sparse nodes.

Now, with reference to FIG. 6, we revisit the uses of the ontology illustrated in FIG. 3, 4 and 5. Taking FIG. 3 first, the portions of a claim are mapped to the ontology 300. Taking the FIG. 6 broad example ontology 600, and considering only one element of the claim for ease of illustration, we suppose for the purpose of illustration that a claim element under consideration maps to concept A.3 in the ontology 600. We further suppose that a portion of the instance under study maps to concept A.3.a.1. Since the concept A.3 is broader than the concept A.3.a.i, the portion of the instance under study (considered in isolation from the other portions) is “covered” by the claim element that maps to the broader concept A.3.

With regard to FIG. 4, as with the discussion relative to FIG. 3, considering only one element of a claim for initial ease of illustration, we suppose for the purpose of illustration that the claim element under consideration maps to concept A.3 in the ontology 600. We further suppose that a portion of a prior art instance maps to concept A.3.a.i. Since the concept A.3 is broader than the concept A.3.a.i, the portion of the prior art instance is covered by the claim element that maps to concept A.3 (again, taking the claim element in isolation). Depending on whether/how other portions of the prior art instance are covered by the other claim elements, a patentability/validity determination is made with respect to that prior art instance.

With respect to formulating patent claims, as broadly illustrated in FIG. 5, on an individual element basis (i.e., assuming for all other claim elements, other than a particular claim element being formulated, the concept to which that claim element maps coincides with a concept to which a portion of the prior art instance maps), a relevant inquiry is how broadly the particular claim element can be formulated without mapping to a concept that is broader than or equal in scope to the concept to which a portion of the prior art instance corresponds.

For example, referring to the FIG. 6 ontology 600, it is assumed that a portion of the prior art instance maps to concept A.3.a.i and a corresponding portion of the instance to which a claim is to be drawn maps to concept A.3.c.ii. Conceivably, then, the claim element could be formulated to map to concept A.3.c. However, if the claim element was formulated to map to concept A.3, the “next” level up from concept A.3.c, then the claim element would “cover” the portion of the prior art instance.

While the discussion has been focused on comparing the mapping of a single concept, this focus was for simplification of illustration. It should be understood that the mapping comparison (in FIGS. 3, 4 and 5) is on a concept by concept basis. For example, using the FIG. 3 process for illustration, an instance under study may be found to infringe a patent claim if every concept to which the elements of the instance under study map is “covered” (taking into account the interrelationships between concept nodes represented by the one or more ontologies) by a concept to which an element of the patent claim maps.

It is noted that considerations of obviousness (referred to in some jurisdictions as “lack of inventive step”) have not been discussed here but are discussed later in this description.

More on Formulation of Claims

In the above discussion, the described analysis was isolated to a portion of a claim and/or instance that maps to a single concept. This was done to simplify the description, to provide a basis for discussion of a more complicated situation involving mapping multiple portions of a claim or instance to multiple concepts (i.e., a mapping of a combination of portions to a combination of concepts). With respect to FIG. 3 (the infringement analysis) and FIG. 4 (the validity/patentability analysis), the concepts to which the portions of the patent claim are mapped may provide a starting point for the analysis. That is, a determination of whether the claim is infringed (FIG. 3) or invalid/unpatentable (FIG. 4) is made substantially by comparing the mapping of the portions of the instance under study (FIG. 3) or of the prior art instance (FIG. 4) to the mapping of the claim.

The analysis with respect to FIG. 5 (claim formulation), however, may not be so straightforward. Rather, many permutations of concepts can (and should) be considered in formulating claims, so long as there is support for a particular claim in the embodiment (i.e., the mapping of the embodiment to the concept nodes of the ontology) and the prior art reference (i.e., the mapping of the prior art reference to the ontology) is such that the particular claim is patentable. (And, as discussed below, the support can perhaps be modified; the prior art cannot.)

In one example, illustrated in FIG. 7, a two-part process 700 is utilized to accomplish the FIG. 5 process. In step 702, the concepts to which the embodiment maps are used as a basis for initially formulating claims, without explicit reference to the concepts to which the prior art reference maps. In step 704, initially formulated claims are evaluated with respect to the prior art reference, using a process like the process used in the FIG. 3 infringement determination and the FIG. 4 validity/patentability determination.

In some examples, the initially formulated claims are formulated in step 702 in a “dumb” manner, without regard to the probability that a particular initially formulated claim will (or will not) be positively evaluated in step 704. With some intelligence, some potential initially formulated claims can be eliminated even before being evaluated. For example, based on a negative evaluation of one particular initially formulated claim, other potential initially formulated claims may be a priori negatively evaluated. One example is a particular initially formulated claim in which all of the concepts to which the particular initially formulated claim elements map are also concepts to which a single prior art instance maps. For example, we consider a slightly different claim, that is identical to the particular initially formulated claim, but, in place of one single element, has another single element that maps to a concept that is broader than the concept to which the single element maps. The slightly different claim will, a priori, be evaluated to be unpatentable based on the negative evaluation of the particular initially-formulated claim. Thus, the slightly different claim is not evaluated in some examples.

In some examples, a “tree” of claims is generated, representing potential initially formulated claims and conceptual relationships between those potential initially formulated claims. Based on the evaluation in step 704, the “tree” is pruned to eliminate the need to process (in step 704) further initially formulated claims that have no probability of being positively evaluated in step 704. The term “tree” as used is meant to apply to any data structure that represents the relationship between the initially formulated claims in a way that some of the initially formulated claims can be determined to have no probability of being positively evaluated in step 704. Furthermore, in some examples, the initially formulated claim is not actually a full fledged claim. Rather, the initially formulated claim is a somewhat raw indication of a combination of concepts from which a full fledged syntactically and grammatically correct claim could be generated.

Yet furthermore, the initially formulated claims may not be generated “in batch.” That is, FIG. 7 is not meant to imply a particular order of initially formulating all the claims in step 702 before evaluating any of the claims in step 704. In some examples, the formulation of claims in step 702 is informed by the evaluation in step 704 to increase probability that a particular initially formulated claim qualifies with respect to the prior art reference.

Description Modification

In some examples, a formulated claim that is derived from the concepts to which the embodiment instance maps, and is capable of being positively evaluated with respect to the prior art reference, deviates enough in scope from the embodiment instance that the embodiment instance description may not provide proper support for the formulated claim. That is, in such cases, the instance can be thought of as a building block for a claim, where the scope of the claim elements is “suggested by the embodiment as opposed to being constrained by the embodiment. The constraint on the scope of the claim elements is, similar to that discussed above with regard to invalidity, constrained by the scope of prior art instances. In some embodiments, then, claims are proposed with elements matching nodes to which the elements of the embodiment are mapped, and various permutations of concepts (initially formulated claims) are proposed which build on the other proposed claims but are constrained only by the combination of concepts to which the prior art instances map. In an extreme case, the prior art mapping may be used as a basis for formulating the claims and, based on the formulated claims (i.e., the concepts to which the formulated claims map), the embodiment instance description is generated and/or enhanced.

A process is provided to evaluate the description (i.e., the concepts to which the description maps) relative to the concepts to which the formulated claim maps, and to suggest enhancements to the description. For example, if a formulated claim is such that, in at least some aspects, it is broader than the embodiment, there may be insufficient description to satisfy the “written description” requirement under United States patent law. As another example, the written description requirement may be implicated if elements of the embodiment are omitted. (See, for example, the Gentry Gallery case from the Court of Appeals for the Federal Circuit.) As another example, which is particularly applicable in “unpredictable art” (e.g., life sciences), the description may be inadequate to meet the burden of establishing utility.

Building Ontologies

We briefly discussion building ontologies. There has been a fair amount of previous work regarding building ontologies in general. For example, see IBM Research Report—GlossOnt: A concept-focused Ontology Building Tool, by Youngja Park, dated Nov. 7, 2003. (Note, this is a pre-release version available to “members of the scientific community.”) The method by which the ontologies are built is not significantly material, so long as they are at least characterized by the property of containing knowledge from which it is determinable whether a particular concept is broader, narrower, or not related to another concept in a patent claim scope sense. Furthermore, the degree to which an ontology is populated with concepts will affect the efficacy of the ontology for the disclosed analysis processes.

Furthermore, it should be noted that an ontology need not be completely (or, perhaps, at all) “pre-built.” That is, in some examples, the ontologies are partially or fully built “on the fly” as they are being mapped to. See, for example, the Woods article cited above regarding conceptual indexing.

More Specifics of Mapping Claim Elements to Ontologies

As discussed above, under United States patent law, the elements of a patent claim are supposed to be supported by the specification of that patent (which includes, for example, a description of one or more embodiments) as viewed by one of ordinary skill in the art. One of ordinary skill in the art is a hypothetical person with knowledge and qualities as set forth by applicable patent doctrine. According to claim interpretation doctrine, the scope of a claim element (and, thus, the node to which the claim element is properly mapped) is typically not determinable without reference to the specification. For example, even if the scope of a claim element appears to be clear on its face, there is a doctrine that “a patentee may be his own lexicographer.” That is, the scope of a claim element may be defined by the patentee to be something other than the scope for that element that would otherwise be known by one of ordinary skill in the art. This would be discernible only with reference to the definition, in the specification. As another example, the scope of a claim element may be ambiguous on its face, and (hopefully) the ambiguity can be resolved with reference to the specification.

Because the claim elements are supposed to be supported by the specification, in some embodiments, the elements of the embodiments described in the patent specification (to which the claims being mapped are appended) are mapped to the concept nodes. The language of the patent description is typically more concrete, and less abstract, than the language of the claims. (Where the prosecution history is available, this, too, can be useful in a similar manner for determining an appropriate claim scope as set forth by applicable patent doctrine.) Then, when mapping the claim elements, the previously-determined mapping of the elements of the embodiments is used, at least as a guide, to determine to what concept node to map each claim element. For means plus function claim elements under 35 USC § 112, ¶ 6, the mapping of elements of the embodiments may take a more central role, as the description is supposed to be the starting point for determining the scope of a means plus function claim element.

As discussed above, the “connection” between claim elements may be explicitly stated within the recitation of an element itself, or the “connection” may be separately stated, as a separate element. In some embodiments, a “connection” between elements is mapped to an ontology of “connection” concept nodes. Examples of a “connection” include, but are not limited to, signals provided between software and/or hardware modules (e.g., “a signal representative of a voltage generated by module . . . ”) or manner of mechanical connection (e.g., “rotatably connected” or “screwed”). In infringement and invalidity determinations, as well as a determination of appropriate claim scope, discussed below, the “connection” ontologies may be processed in a manner similar or identical to the ontologies to which other elements are mapped.

Mapping Instances to Ontologies

The mapping of textual description to ontologies is known. For example, see the Mahesh article. See, also, A CG-Based Behavior Extraction System, Proc. Seventh International Conference on Computational Structures, Blacksburg, Va., 127-139, Jul. 12-15, 1999, which describes analyzing natural language sources and representing, in a formal manner, the behaviors described by those sources. Thus, for example, the CG-based behavior extraction system may be used, as appropriate, to represent the behavior of particular elements (instance, claim, etc.) that nominally map to the same concept but may differ at a finer level. Certainly, the Woods article discussed above offers great detail about mapping textual description to ontologies.

We consider that the finer behavioral level may be represented as a further development of the conceptual division, where, perhaps, the behavior being represented is sufficiently individualized such that it less economically feasible to have a separate concept “reserved” in the ontology for that behavior. Rather, essentially, the concept node is parameterized such that various concepts (behaviors, in this case) can be represented without pre-conceiving what particular values the parameters will or may take. As a practical matter, as enough behaviors are represented parametrically with respect to a particular concept node, computational efficiencies (e.g., in processing the ontologies) may be gained by converting the various representations to actual concept nodes that are “related” to the particular concept node.

The parametric representation need not be limited to behaviors. For example, a parametric representation may be used to represent ranges of, or a specific percentage of, a composition, ranges of a specific angle, and numerous other properties. By this discussion, we have intended to illustrate that the parametric representation can be thought of as equivalent to the conceptual representation, at least from the point of view that, from these representations, it is determinable whether a particular concept (whether represented by the particular concept node itself or by the more specific parametric representation) is broader, narrower or not related to another concept in a patent scope sense. In some sense, then, a chose between the two representations is driven by practical considerations rather than by theoretical considerations, and each may be considered as part of an “ontological representation.”

Turning back to the notion of how instances may be expressed, instances may also be expressed in tangible ways other than by text. For example, the instances may be expressed in a written specification that includes text and/or figures. As another example, the instances may be expressed using a modeling language such as Universal Modeling Language (UML) or may even be constituted of executable source code, such as in FORTRAN, C or C++, for example, or even a hardware design language. As another example, the elements of the embodiment may be expressed as a bill of materials (BOM). As yet another example, the instance may be expressed using Resource Description Framework (RDF) or similar semantic frameworks.

The ontologies (or multiple ontologies) are typically, but not necessarily, embodied in a computer-readable tangible medium. The mapping operations, as well as the correspondence processing operations are carried out using a computer, such as a general purpose computer programmed to carry out such operations. Furthermore, the operations of mapping, may be carried out (or at least communicated) via a computer network in a collaborative manner, such that, in this way, the effort to perform such operations are distributed among a plurality of (typically) unrelated users. A moderator/administrator may evaluate the mapping operations before allowing a particular mapping result to be made available for use by the community of users at large.

Example Architecture

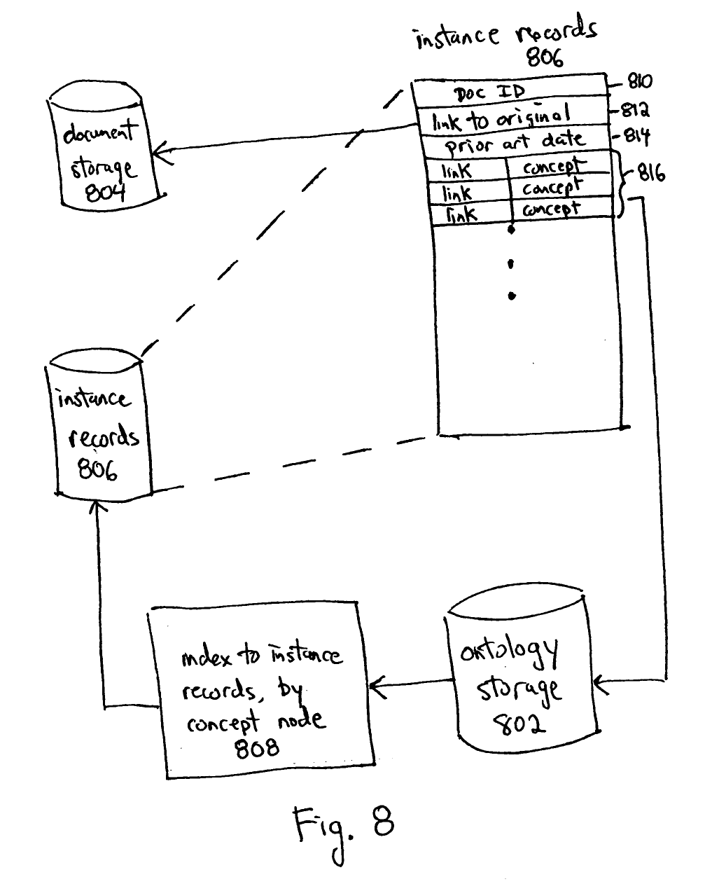

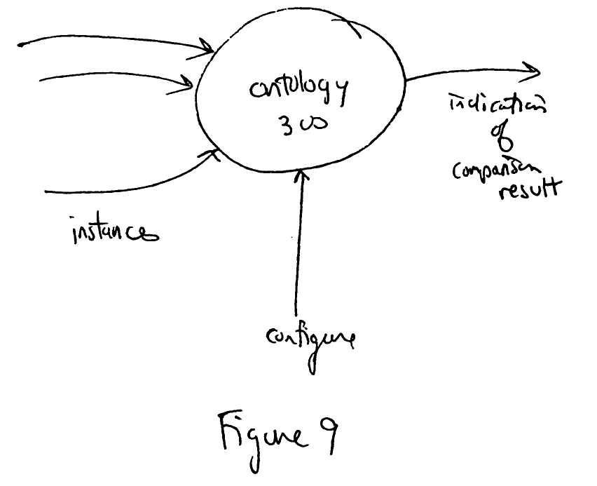

FIG. 8 illustrates an example architecture of a system that may be employed to carry out the methods described herein. A data store 802 holds a one or more ontology representations. (Without being metaphysical, an “ontology” is strictly not something real. For ease of description, we sometimes refer to an “ontology” when we mean a representation of an ontology.) For example, the data store 802 may be a centralized or distributed computer-readable storage medium. A data store 804 (again, centralized or distributed) holds “documents” (textual and/or other representations) of instances.

A data store 806 holds instance records, which may be centralized or distributed. Where the instance records pertain to information specific to a particular entity (e.g., designs by a particular company), then instance record would typically be centralized in an area accessible only by that company, for protecting trade secrets and/or other competitive reasons, or for other reasons. This could also pertain to document storage 804. The instance records include information about an instance, such as a document ID 810 in the document storage 804, a link 812 to the original document from which the instance is derived, one or more “prior art” dates 814 for the instance, and a list 816 of concepts in the ontology storage 802 to which the instance maps.

Furthermore, an index 808 is maintained to the instance records for the concept nodes in the ontology storage 802, which facilitates indexing into the instance storage 806 as a function of concepts in an ontology represented in the ontology storage 802.

We now discuss briefly how the FIG. 8 architecture may be employed in the methods of FIGS. 3, 4 and 5. With regard to FIG. 3, as an example, the ontology 300 (802 in FIG. 8) may have a plurality of potentially infringing instance records 806 associated with it. As an example, once the concept node mapping of a particular non-expired claim is determined, this mapping is used as a starting point to determine whether one or more potentially infringing instances (based on the mapping 816) are “covered” by the particular non-expired patent claim. This may be accomplished, for example, by starting with the index 808, indexing into the instance records 806 based on the concept nodes to which the particular non-expired claim maps, thereby obviating (or, perhaps, minimizing) the need to consider at all potentially-infringing instances that do not map to a current node that covers a concept node to which an element of the particular non-expired patent claim maps. Put simply, one can start the comparison using the concept nodes to which the particular non-expired claim maps, rather than inspecting the mapping of a list of potentially infringing instances, many of which can be easily determined to actually have no possibility of being covered by the particular non-expired claim (i.e., it can be easily determined from the concept node mapping that the potentially infringing instance is missing at least one element of the particular non-expired claim). As a practical matter, in operation for example, a holder of multiple patents may maintain a library of allegedly infringing instances and use the FIG. 3 method to determine instances which are covered by non-expired claims of the multiple patents.

Similar to the discussion immediately above with reference to FIG. 8 and FIG. 3, we now discuss FIG. 8 and FIG. 4. For example, a particular patent claim may be mapped to the ontology 300 (802 in FIG. 8) and the mapping compared to the mapping of a plurality of potentially invalidating instances. The process could be similar to that described above with reference to FIG. 3 and 8, when, typically, a library of instance records 806 is maintained of prior art instances. Also, given a particular “effective date” of a patent claim, the prior art instance records 806 may be filtered such that non-applicable prior art instances are not considered with respect to a particular patent claim.

With regard to FIG. 5 and FIG. 8, again, a library of instance records 806 may be maintained of prior art instances, and the mapping of the embodiment (including the initially formulated claims, See FIG. 7) would be compared to the mapping of the prior art instances using a combination of the instance records 806 and the index 808 to the instance records.

Furthermore, similar to the document storage 804, claim storage 818 may be maintained. In some cases, the instances in the document storage 804 may be intermingled with claim storage 818, as may be the case, for example, with instances described in prior art patent documents and claims recited in those same prior art patent documents. Claim records 820, similar to the instance records 806 (denoted in FIG. 8 as “instance or claim records 806” as an indication of the similarity therebetween), may be maintained holding a concept node mapping of the portions of the claims. Furthermore, an index 822 to claim records 820 by concept node may be maintained, similar to the index to instance records 808. The claim storage 818, claim records 820 and index to claim records by concept node 822 may be processed in a manner similar to the manner in which the document storage 804, instance records 806 and index to instance records by concept node 808 are processed as, for example, described above.

Handling Issues with Respect to Obviousness

With respect to the comparisons involved in the FIGS. 3-5 methods, there may not be a direct mapping, yet the comparison may be significant. A mapping that is not direct, but is “close” in some regard, implicates considerations of obviousness. In this case, generally, the process includes determining whether appropriate combinations of instances may be employed in place of a single instance. Whether such combinations are appropriate depends, at least in part, on relevant doctrines of patent law (e.g., in the United States, requiring a motivation or suggestion to make the combination).

We note that, similarly, the “closeness” considerations are useful in the infringement determination, where there is no direct anticipation, but where an argument may be made that there is infringement under the doctrine of equivalents. Also, the “closeness” considerations are useful, in perhaps a slightly different way, in the processing of means plus function claim elements, where “closeness” may be an aid in determining the literal scope of the means plus function claim element via the “equivalents” portion of the scope definition of means plus function claim elements.

Competitive Product Intelligence

Ontologies are also useful, for example, in a manner similar to at least some of the description above, for applications in competitive product intelligence (CI). In CI, issues arise of both gathering information and then on being able to process the gathered information in order to analyze it. Conventional CI systems known to the inventor, in general, tend to summarize large amounts of gathered information, in an attempt to put the information in a form that can supposedly be acted upon by businesses in setting forward-looking strategies. By summarizing the gathered information, however, details—many of which may be highly relevant—are obscured or ignored. Using ontologies such as those discussed above, the gathered information may be processed without obscuring differences in details.

Referring to FIG. 9, gathered information (“instances,” which may or may not include patent claims) is mapped to concept nodes of an ontology 300. Furthermore, information regarding the “subject” (also “instances”) is also mapped to concept nodes of the ontology 300. The gathered information may include, for example, information regarding one or more “subjects” such as the user of the method, competitors of the user and/or others. The information may be, for example, specifications describing current commercial offerings (e.g., products, methods, services, etc.). The information regarding the subject may be, as another example, specifications regarding proposed future commercial offerings. The results of the CI analysis may be determined, for example, by comparing the mappings of the gathered information. The element-by-element matching may be carried out as described above with respect to FIGS. 3, 4 and 5. The results of the comparison indicates how the concepts represented in the instances of the gathered information correspond to and/or differ from the concepts represented in other instances in the gathered information. More specifically, such comparison accounts for subsumption relationships between the concepts to which one instance maps and the concepts to which another instance maps. Furthermore, the results indicates such subsumption relationships.

As another example, instances in the gathered information may pertain to a particular product over one or more dimensions. One dimension may include time, but other dimensions may include variables such as amount of venture capital investment, unemployment rate, or technology spending. These are just examples, and are not meant to imply that the dimension or dimensions utilized is so limited. There are various ways to indicate a result of the comparison, including tables, graphically, etc. Furthermore, the indication may be user configurable to focus, for example, on a desired level of detail, on a particular desired concept, or on other aspects of the comparison.

In any event, the “instances” (as this word is used above relative to patents) may be more generally thought of as patent claims, product information, prior art apparatuses or methods, etc. In accordance with a broad aspect, the instances (as indicated by some tangible representation thereof) are mapped to one or more ontologies, and the mappings are processed to determine differences (at an elemental concept level) between the instances.

As yet another example, the FIG. 9 process may be useable to compare two patent claims. This may be desirable, for example, to determine if a particular claims “interfere” (see, for example, 35 USC § 135, and corresponding rules, cases and/or doctrine) or if a particular claim is “dominant” over another claim. There may be other situations in which such a claim comparison would be useful.

The claims appended hereto, while not necessary for a provisional application filing, are provided as a representative sample of the subject matter that may be claimed later in a subsequent non-provisional patent filing.

1. A method of analysis, comprising:
a) determining a first correspondence, of the portions of at least a first instance to the concept nodes of an ontology;
b) determining a second correspondence, of the portions of at least a second instance to the concept nodes of the ontology;
c) processing the determined first correspondence and the determined second correspondence, including specifically considering subsumption relationships between concept nodes of the first correspondence and concept nodes of second correspondence.

2. The method of analysis of claim 1, wherein:
the processing step includes determining at least one matching between the concept nodes of the first correspondence and the concept nodes of the second correspondence.
